(19) United States
(12) Patent Application Publication
(10) Pub. No.: US 2025/0118168 A1
(43) Pub. Date: Apr. 10, 2025

(54) SYSTEM AND METHOD FOR PLAY OF A SCRATCH-OFF LOTTERY TICKET GAME ACROSS MULTIPLE JURISDICTIONS

(71) Applicant: Scientific Games, LLC, Alpharetta, GA (US)

(72) Inventors: Joseph Waldo Bennett, III, Suwanee, GA (US); Ashley Ivery Gantt, Woodstock, GA (US)

(21) Appl. No.: 18/481,720

(22) Filed: Oct. 5, 2023

(51) Int. Cl. G07F 17/32; G07F 17/42

(52) U.S. Cl. CPC G07F 17/329; G07F 17/323; G07F 17/42

(57) ABSTRACT

A method and system for play of an instant lottery ticket game system by a plurality of jurisdictions includes providing a first set of instant lottery tickets for a primary game to each jurisdiction. A top prize is provided in the primary game. An independent prize structure for lesser prizes in the primary game is assigned to each of the first sets. For each of the first sets, an independent number of the instant lottery tickets are designated as eligible tickets with a chance to win the top prize in the primary game. From a pool of the eligible tickets, the top prize is randomly assigned to one of the eligible tickets. The identity and location of the top prize winning ticket is kept secret from the jurisdictions before and during play of the primary game in the jurisdictions.

### FIELD OF THE INVENTION

The present invention generally relates to a system and method for implementing a scratch-off lottery ticket game, and more particularly to a method wherein lottery tickets eligible to win a top tier prize are randomly distributed across multiple jurisdictions.

### BACKGROUND

“Scratch-off” or “instant-win” lottery tickets have enjoyed immense popularity in the lottery industry for decades. These games offer distinct advantages to the lottery authorities and are attractive to a broad spectrum of players.

The scratch-off lottery ticket games typically have a multi-tiered prize structure with relatively few prizes at the top tier level. The number of predetermined winning tickets in each tier increases as the prize tiers are further removed from the top prize tier level. The top prizes can be quite attractive to potential players and are often advertised extensively to draw players to the game.

Particularly in Europe and the U.S., multi-jurisdictional games exist wherein a common scratch-off lottery ticket game is played across multiple jurisdictions, such as separate countries in Europe or separate states in the U.S. These games have a common prize structure wherein the number and value of prizes (including the top tier prizes) are predetermined based on the payout of the game and the total number of tickets allocated to the game. For example, a game having five million tickets provided throughout the jurisdictions may have five top tier prizes (and a number of lesser tier prizes), whereas a game having twenty million tickets provided throughout the jurisdictions with the same payout percentage may have twenty top tier prizes (and a number of lesser tier prizes). All of the prizes (including the top tier prizes) are randomly distributed throughout the jurisdictions. Thus, it is possible that one or more of the jurisdictions may not receive a top tier prize ticket, or even that a single jurisdiction may receive all of the top tier prize tickets.

With the conventional practice, each jurisdiction is provided with a validation file for the lottery tickets provided to the jurisdiction, the validation file containing a record of each winning lottery ticket within the jurisdiction. Thus, the jurisdiction is aware of the number of top tier prize tickets that can possibly be won by patrons within the jurisdiction. This situation creates a dilemma for the jurisdictions. Specifically, a jurisdiction may offer lottery tickets to its citizens advertising the chance to win a top tier prize (e.g., “Win a top prize of $1 Million!”) yet be aware (from the validation file) that no top tier prize tickets are even available for sale in the jurisdiction. Even if one or more top tier prize tickets were initially available and known to the jurisdiction, the same dilemma exists when the jurisdiction becomes aware that these winning tickets have been redeemed and no more top tier prize tickets exist in the jurisdiction but may still be available in other jurisdictions.

Certain lottery jurisdictions around the world (particularly in the U.S. and Europe) have adopted the practice of publicizing to patrons on a periodic basis (e.g., daily or weekly) the number of prizes remaining in each tier of the prize structure for individual scratch-off lottery ticket games. For various reasons (which may include consideration of the dilemma discussed above), these jurisdictions will also terminate the game when all of the top tier prizes have been awarded. For example, if a particular game has three top prizes worth $500,000 each, the game will end when the last of the three $500,000 prizes has been awarded. The unsold scratch-off lottery tickets remaining in the game are pulled from the point-of-sale locations and are typically destroyed.

The above-described practice is, however, disadvantageous in certain respects. Scratch-off lottery ticket games have a design payout based on play of a percentage of the complete run of lottery tickets in the game (the total number of tickets printed and made available for sale and play of the game). For example, a particular game may have a ticket run of ten million tickets with a designed payout of 50%, meaning that half of the money generated by ticket sales is paid out as prizes and the other half of the money constitutes lottery revenue for the jurisdiction. If a game is prematurely ended after the top prizes have been awarded, the payout percentage can be significantly increased to the detriment of the jurisdiction. For example, the game mentioned above having a ticket run of ten million tickets may be terminated after the sale of only two million of the tickets because the three top prizes were awarded. The lottery jurisdiction then loses the revenue from the sale of up to eight million additional tickets. The payout percentage at the early termination of the game may be, for example, 70% of the proceeds generated by sale of the two million tickets, which is significantly greater than the 50% designed payout.

U.S. Pat. No. 7,153,206 proposes an instant lottery ticket game structure includes a ticket validation file containing prize codes for at least some of the lottery tickets (i.e., at least the winning tickets). Provision is made for certain of the instant lottery tickets to have a variable redemption value by allowing the prize codes in the validation file to be changed under certain predetermined circumstances. These tickets, whether printed or electronically simulated, are provided with play indicia under a removable coating that indicates that the redemption value of that lottery ticket is variable. Using the host computer, a lottery administration can change the prize codes and therefore the redemption value of these instant lottery tickets according to the predetermined criteria such as the termination of a game. In some cases, a player can have the option to redeem an instant lottery ticket for a first value or wait until after termination of the game where a possibly higher redemption value might be assigned to that ticket due to the host computer randomly selecting that ticket to change its prize code to a greater value.

The industry, lottery jurisdictions, and public in general would benefit from additional improved methods and game systems to alleviate the dilemma and consequences discussed above that are faced by jurisdictions in a multi-jurisdictional game.

### SUMMARY

Objects and advantages of the invention will be set forth in part in the following description, or may be obvious from the description, or may be learned through practice of the invention.

In accordance with aspects of the invention, a method is provided for implementing an instant lottery ticket game system played by a plurality of jurisdictions. The jurisdictions may be, for example, a state, region, or other municipality that has authorized the play of lottery games within its borders or boundaries. For example, in the United States, each state may be considered as a separate jurisdiction. In Europe, each country may be considered as a separate jurisdiction, or regions within a country may be considered as separate jurisdictions. The lottery game systems are generally provided to the jurisdictions by a third-party game provider that may also administer certain administrative and accounting aspects of the games.

The method includes designating a first set of instant lottery tickets in a primary game for each of the jurisdictions, the primary game having at least one top prize assigned thereto. An independent predetermined prize structure for lesser prizes in the primary game is determined and assigned to each of the first sets such that each jurisdiction has an independent prize structure for the lesser prizes. The respective jurisdiction may determine the number of prizes and value of this prize structure completely independent from the prize structure in any other jurisdiction. Indicia is provided on each of the instant lottery tickets in all the first sets that identifies a chance to win the top prize. For each of the first sets, the method includes defining an independent number of the instant lottery tickets as eligible tickets with a chance to win the top prize in the primary game. From a pool representing the eligible tickets from all of the first sets, the top prize is randomly assigned to one of the eligible tickets, thereby designating a top prize winning ticket to be printed. The first sets of instant lottery tickets are printed with the top prize winning ticket located in one of the first sets. The method includes maintaining the identity and location of the top prize winning ticket secret from the jurisdictions before and during play of the primary game in the jurisdictions.

In a particular embodiment, more than one top prize may be awarded, and the method may include randomly assigning each of the top prizes to a respective eligible ticket from the pool of eligible tickets, thereby designating and printing a plurality of the top prize winning tickets that are located in one or more of the first sets.

In a further embodiment, the method may include randomly assigning each of a plurality of instant-win prizes to a respective eligible ticket from the pool of eligible tickets, thereby designating and printing instant-win prize tickets, the instant-win prizes having a lesser value than the top prize. The instant win prize tickets located in one or more of the first sets.

In the various embodiments, each of the instant lottery tickets in all of the first sets may include play area indicia that identifies whether or not the instant lottery ticket is the top prize winning ticket or an instant-win prize ticket.

The number of eligible tickets within each of the first sets may be variously determined. For example, the number of eligible tickets may be based on the number of the instant lottery tickets provided to each of the jurisdictions in the primary game such that a jurisdiction that purchases a greater number of tickets in the primary game is ensured a greater number of the eligible tickets in its first set. Alternatively, the number of eligible tickets within each of the first sets may be randomly determined such that each jurisdiction is ensured that their first set includes at least one eligible ticket but the total number of eligible tickets in their first set is not made known to the jurisdiction.

Once the random assignment of the top prizes and the instant win prizes throughout the jurisdictions have been made, the method may include printing the instant lottery tickets. The algorithms used for the printing process will be controlled to ensure that the correct number of eligible tickets are printed for the respective jurisdictions and the random distribution of the top prizes, and the instant win prizes are made within the pool of eligible tickets in a highly secure and confidential manner.

Certain embodiments of the method may include generating a validation file for each jurisdiction that contains a record of each of the instant lottery tickets in the first set that wins one of the lesser prizes within the prize structure assigned to the first set. These jurisdiction-specific validation files are provided to each jurisdiction and are void of a record or information that identifies location of the top prize winning ticket (or the instant-win prize tickets) to the jurisdiction.

The method may include generating a confirmation file that contains information to validate the top prize winning ticket (and any instant prize winning tickets), wherein this confirmation file is maintained by a lottery provider or third party without access thereto by the jurisdictions.

The method may further include providing instructions to a player on the top prize winning ticket (and any instant prize winning tickets) on how to validate the top prize winning ticket via the lottery provider or third party separate from a validation process maintained by the jurisdiction for the lesser prizes in the primary game. The top prize may, however, be awarded to the player by the jurisdiction in which the top prize winning ticket was sold.

In various embodiments, the instant lottery tickets are scratch-off lottery tickets having game play indicia for the lesser prizes and indicia indicating whether the ticket is the top prize winning ticket or an instant-win prize under a removable scratch-off coating.

The present invention also encompasses an instant lottery ticket game system for play in a plurality of jurisdictions, wherein the system includes a first set of instant lottery tickets for a primary game for each of the jurisdictions, the primary game having at least one top prize assigned thereto. The system includes an independent predetermined prize structure for lesser prizes in the primary game for each of the first sets such that each jurisdiction has an independent prize structure for the lesser prizes. Indicia is provided on each of the instant lottery tickets in all the first sets that identifies a chance to win the top prize. In each of the first sets, an independent defined number of the instant lottery tickets were designated as eligible tickets with a chance to win the top prize in the primary game. From a pool representing the eligible tickets from all the first sets, one of the eligible tickets was randomly assigned as a top prize winning ticket that wins the top prize. The tickets are printed for all of the first sets with the top prize winning ticket located within one of the first sets. In this system, the identity and location of the top prize winning ticket is maintained secret from the jurisdictions before and during play of the primary game in the jurisdictions.

Embodiments of the system may include a plurality of the top prizes and top prize winning tickets in the primary game randomly assigned to a respective one of the eligible tickets in the pool of eligible tickets, wherein the top prize winning tickets are located in one or more of the first sets.

In addition, the system may include a plurality of instant win prizes and instant win prize tickets randomly assigned to a respective one of the eligible tickets in the pool of eligible tickets, the instant-win prizes having a lesser value than the top prize. The instant win prize tickets are located in one or more of the first sets.

Each of the instant lottery tickets in all the first sets may include play area indicia that identifies whether or not the instant lottery ticket is the top prize winning ticket or an instant-win prize ticket.

The system may include a validation file for each jurisdiction that contains a record of each of the instant lottery tickets in the first set that wins one of the lesser prizes in the prize structure assigned to the first set, wherein this validation file is void of a record or information that identifies location of the top prize winning ticket to the jurisdiction. The system may include a confirmation file that contains information to validate the top prize winning ticket (and any instant prize winning tickets), wherein this confirmation file is maintained by a lottery provider or third party without access thereto by the jurisdictions.

The top prize winning ticket (and any instant prize winning ticket) will include instructions to a player on how to validate the ticket via the lottery provider or third party separate from a validation process maintained by the jurisdiction for the lesser prizes in the primary game.

The instant lottery tickets and the supplemental lottery tickets may be paper or electronic scratch-off lottery tickets having game play indicia under a removable scratch-off coating.

### BRIEF DESCRIPTION OF THE DRAWINGS

A full and enabling disclosure including the best mode of practicing the appended claims and directed to one of ordinary skill in the art is set forth more particularly in the remainder of the specification. The specification refers to the appended figures, in which:

FIG. 1 is a diagram of primary instant ticket lottery game system provided by a game provider to a plurality of jurisdictions;

FIG. 2 is a table representing a fixed multi-tiered prize structure for lesser prizes in a primary scratch-off lottery ticket game that may be embodied in the system of FIG. 1 according to aspects of the present invention;

FIGS. 3A through 3D depict examples of scratch-off lottery tickets that may be played in a primary game in accordance with aspects of the invention; and

FIG. 4 depicts a system and method for play of a primary lottery ticket game across multiple jurisdictions in accordance with aspects of the invention.

### DETAILED DESCRIPTION

Reference will now be made in detail to various and alternative exemplary embodiments and to the accompanying drawings, with like numerals representing substantially identical structural elements. Each example is provided by way of explanation, and not as a limitation. In fact, it will be apparent to those skilled in the art that modifications and variations can be made without departing from the scope or spirit of the disclosure and claims. For instance, features illustrated or described as part of one embodiment may be used on another embodiment to yield a still further embodiment. Thus, it is intended that the present disclosure includes modifications and variations as come within the scope of the appended claims and their equivalents.

Generally, the present disclosure is directed to an instant lottery ticket game system 10 and method 100 that facilitate play of a primary scratch-off lottery ticket game across multiple jurisdictions wherein each jurisdiction has an independent prize structure for lesser prizes and players in all the jurisdictions have a chance to win one or more common top tier prizes. The system and method may be implemented with paper scratch-off lottery tickets or electronic scratch-off lottery tickets that are presented to and played by a patron via a smart device.

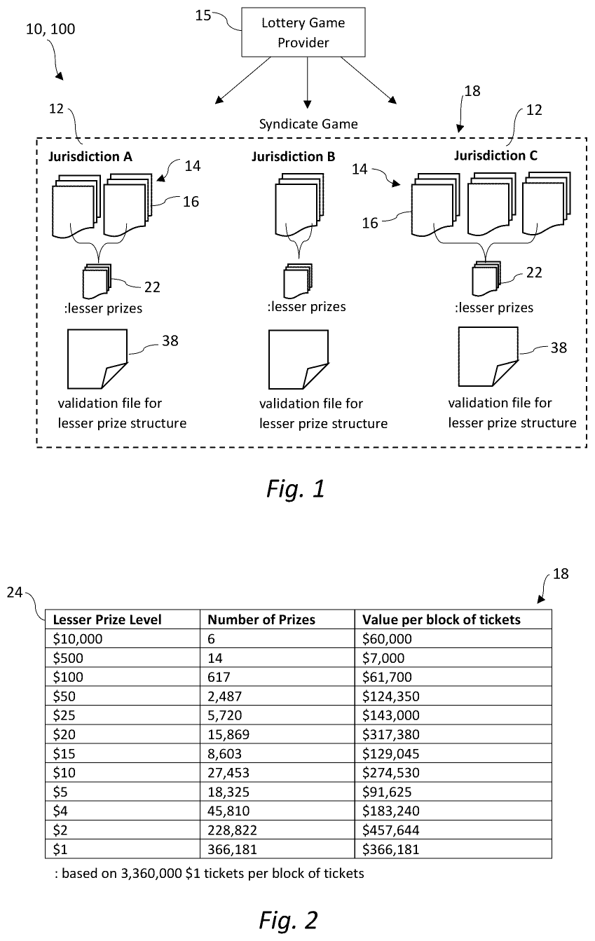

Referring to FIG. 1, aspects of a primary lottery ticket 18 game implemented in a plurality of different jurisdictions 12 are depicted, wherein each jurisdiction may be, for example, a state, region, or other municipality that has authorized the play of lottery games within its borders. The lottery games are generally provided to the jurisdictions 12 by a third-party game provider 15 that may also administer certain administrative and accounting aspects of the games. An example of a game provider is Scientific Games having its global headquarters in Alpharetta, Georgia, USA.

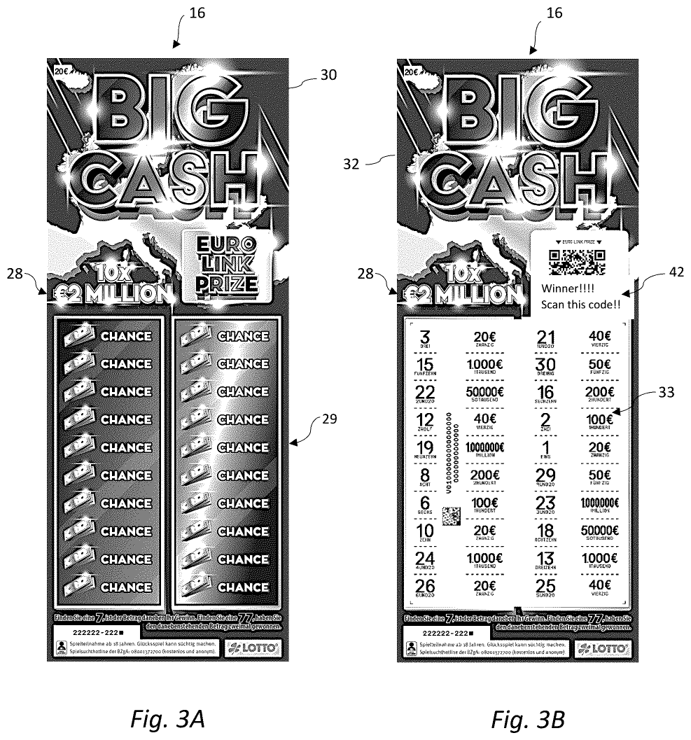

The present method and system include designating a first set 14 of instant lottery tickets 16 for a primary game 18 to be printed for each of the jurisdictions 12, which may be paper or electronic scratch-off lottery tickets. These first sets 14 of instant lottery tickets may share a game theme, such as a sports or holiday theme, and art typically provided to the jurisdictions 12 in “blocks” having a fixed number of tickets. In accordance with the present disclosure, each of the first sets 14 has a fixed, multi-tiered prize structure (FIG. 2) for lesser prizes 22 in the primary game. The top prize (or prizes) is not included in these prize structures. For example, FIG. 2 depicts a block of the lottery tickets 16 one of the first sets 14 of the primary game 18 that has 3,360,000 tickets with the multi-tiered prize structure 24 for lesser prizes in the game. As an example, FIG. 1 depicts that Jurisdiction A is provided with a first set 14 of the lottery tickets 16 in the primary game comprised of two blocks of tickets 16 each having the lesser prize structure 24 depicted in FIG. 2. Similarly, the first set 14 of the lottery tickets 16 in the primary game provided to Jurisdiction B comprises a single block of the lottery tickets 16 having the lesser prize structure 24 depicted in FIG. 2. The first set 14 of the lottery tickets 16 in the primary game provided to Jurisdiction C comprises three blocks of the tickets 16 each having the lesser prize structure 24 depicted in FIG. 2.

The respective jurisdictions A-C may determine the prize structure 24 for the lesser prize component of the primary game 18 completely independent from the other jurisdictions. Thus, the number of lesser prizes 22 and monetary value of these lesser prizes 22 may vary from one jurisdiction to another.

Stiff referring to FIG. 1 the method 10 and associate system 100 may include generating a validation file 38 for each jurisdiction A-C that contains a record of each of the instant lottery tickets 16 in the first set that wins one of the lesser prizes 22 within the prize structure 24 assigned to the first set 14. The generation and use of electronic validation files 38 in the industry is well-known. These files 38 contain an electronic record of each winning ticket and are used to validate a ticket presented by a player for redemption of a prize. Tickets 16 generally include a code that links to its respective record in the validation file 38. The validation files 38 are also used for accountability purposes between the lottery game provider and the jurisdiction, and for various other reasons. For the present method 10, these jurisdiction-specific validation files 38 are provided to each jurisdiction A-C and are void of a record or information that identifies location of top prize winning tickets (or the instant-win prize tickets) to the jurisdiction, as discussed in greater detail below.

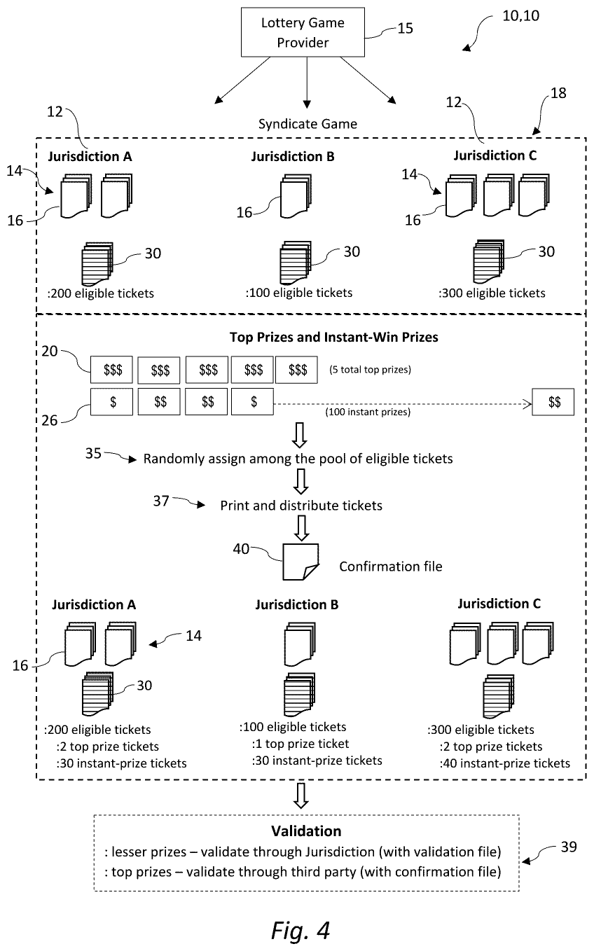

Referring to FIG. 4, the method 10 and associated system 100 include defining an independent number of the instant lottery tickets 16 to be printed for each jurisdiction as “eligible” tickets 30 with a chance to win the top prize 20 (or one of multiple top prizes) in the primary game 18. The number of eligible tickets 30 within each of the first sets 14 may be variously determined. For example, the number of eligible tickets 30 may be based on the number of the instant lottery tickets 16 provided to each of the jurisdictions A-C in the primary game 18 such that a jurisdiction that purchases a greater number of tickets 16 in the primary game 18 is ensured a greater number of the eligible tickets 30 in its respective first set 14. Alternatively, the number of eligible tickets 30 within each of the first sets 14 may be randomly determined such that each jurisdiction A-C is ensured that their first set 14 includes at least one eligible ticket 30 but the total number of eligible tickets 30 in their first set 14 is not made known to the jurisdiction A-C.

It should thus be understood that the top prize 20 is common to all jurisdictions. The players in the various jurisdictions have a chance to win the common top prize(s). The number of top prizes 20 can vary. For example, FIG. 4 depicts that there are five top prizes 20 that can be won in the primary game 18 across all of the jurisdictions.

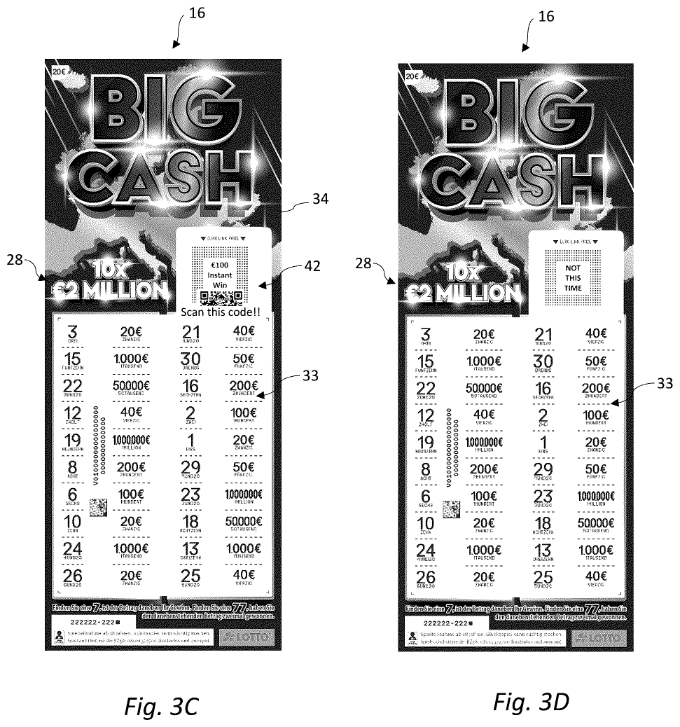

From a pool representing the eligible tickets 30 from all of the first sets 14, at step 35, the method 10 includes randomly assigning each of the top prizes 20 to a respective one of the eligible tickets 30, thereby designating top prize winning tickets 32 (FIG. 3B). The instant lottery tickets 16 for each of the first sets 14 are printed with the top prize winning tickets 32 located in one or more of the first sets. The identity and location of the top prize winning tickets 32 are kept secret from the jurisdictions A-C before and during play of the primary game in the jurisdictions. In other words, the jurisdictions are ensured that a certain number of top prizes 20 were randomly seeded into the pool of eligible tickets 30 such that all of the jurisdictions have a chance that the top prize winning ticket(s) is in their respective jurisdiction. A jurisdiction with a higher number of eligible tickets 30 in the pool of eligible tickets 30 has a greater probability that the top prize winning ticket(s) is in their jurisdiction.

Still referring to FIG. 4, the method 10 may also include randomly assigning each of a plurality of instant-win prizes 26 to a respective eligible ticket 30 from the pool of eligible tickets, thereby designating and eventually printing instant win prize tickets 34 (FIG. 3C). These instant-win prizes 26 have a lesser value than the top prize and may be immediately revealed to the player upon removing the scratch-off-coating from the ticket 16 (discussed in greater detail below). As with the top prize winning tickets 32, the instant win prize tickets 34 are located within one or more of the first sets 14 and the identity and location of the instant prize winning tickets 34 are kept secret from the jurisdictions A-C before and during play of the primary game in the jurisdictions.

The algorithms and systems used for designing scratch-off lottery ticket games are well-known to lottery ticket providers. These systems and their highly secure control processors can be programmed to perform the steps discussed above, including determining the correct number of eligible tickets 30 for each jurisdiction and performing the random and secret assignment of top prize winning tickets 32 and instant prize winning tickets 34 within the pool of eligible tickets 30. Once the random assignment of these tickets 32, 34 has been made, the highly secure printing processors will ensure that the tickets 32, 34 will be randomly seeded and printed within the correct sets 14 of instant tickets 16 for the respective jurisdictions A-C, as depicted by steps 35 and 37 in FIG. 4.

For example, FIG. 4 depicts that the control system operated by the lottery ticket provider determined that Jurisdiction A is assigned two-hundred eligible tickets 30, Jurisdiction B is assigned one-hundred eligible tickets 30, and Jurisdiction C is assigned three-hundred eligible tickets 30. This results in a pool with six hundred eligible tickets 30. From this pool, the random generation program determines that Jurisdiction A is assigned two top prize winning tickets 32 and thirty instant prize winning tickets 34. Jurisdiction B is assigned one top prize winning ticket 32 and thirty instant prize winning tickets 34. Jurisdiction C is assigned two top prize winning tickets 32 and forty instant prize winning tickets 34. The printing algorithms and processes will ensure that the winning tickets 32, 34 are randomly and securely printed within the respective sets 14 delivered to the jurisdictions A-C

As depicted in FIG. 4, the method 10 and system 100 may include generating a confirmation file 40 that contains information to validate the top prize winning ticket. This confirmation file 40 is not part of or a component of the validation files 38 and is maintained by the lottery provider 15 or another third party. The jurisdictions do not have access to the confirmation file 40 and, thus, cannot ascertain the identity or location of the top prize winning tickets 32 or instant prize winning tickets 34 via the confirmation file.

Referring to FIGS. 3A-3D, various depictions of an example of the instant lottery ticket 16 are provided. FIG. 3A depicts a ticket 16 that is presented to a player. The ticket 16 includes indicia 29 related to play of the primary game 18 for the lesser prizes, which may be printed on a scratch-off layer that overlies the game-play symbols 33. Indicia 28 is also provided on all of the tickets 16 in the primary game 18 that advertises the chance to win a top prize (e.g., a 2 million euro prize). The ticket 16 in FIG. 3A may or may not have been an eligible ticket 30 in the pool of eligible tickets 30 discussed above. There is no need to indicate the status of the ticket as a “pool ticket” on the face of the un-played ticket 16.

It should be appreciated that designation of the initial eligible tickets 30 is a means to define a pool of simulated tickets from which the top prize tickets (and instant prize tickets) would be randomly drawn/assigned. Each “entry” in the pool is simply represented by an eligible-designated ticket 30 from one of the first sets. Once the number of top prize winning tickets 32 and instant prize winning tickets 34 are randomly selected from the pool and seeded throughout the first sets 14, the pool of eligible tickets is not needed.

FIG. 3B depicts a top prize winning ticket 32 (e.g., wins the 2 million euro prize). The ticket 32 has indicia 42 under a section of the scratch-off coating that instructs the player on how to validate the top prize winning ticket 32 via the lottery provider 15 or another third party separate from the validation process maintained by the jurisdiction for the lesser prizes 22 in the primary game 18. For instance, the indicia 42 instructs the player to scan the provided code, which will link the ticket to the confirmation file 40 maintained separate from the validation file 40. The player may be instructed to redeem the top prize winning ticket 32 at a lottery office in the jurisdiction in which the top prize winning ticket 32 was purchased, wherein the lottery provider or third party sends a confirmation notice to the lottery jurisdiction in order for the ticket to be redeemed.

FIG. 3C depicts a ticket 16 that was also an eligible ticket 30 and is an instant prize winning ticket 34, as discussed above. This ticket 34 can be redeemed by the player in the manner discussed above with respect to the top prize winning ticket 32 of FIG. 3B.

FIG. 3D depicts a ticket 16 in the primary game that was not one of the eligible tickets 30. Thus, this ticket was not capable of being a top prize or instant prize winning ticket.

It should be noted that each of the tickets 16 depicted in FIGS. 3A-3D may be a winning ticket in the lesser prize structure within the respective jurisdiction in which it was purchased regardless of its status as a top prize 32 or instant prize winning ticket 34.

Those skilled in the art appreciate that the present methods and systems may be implemented by conventional technology that may include servers, computers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

The material particularly shown and described above is not meant to be limiting, but instead serves to show and teach various exemplary implementations of the present subject matter. As set forth in the attached claims, the scope of the present invention includes both combinations and sub-combinations of various features discussed herein, along with such variations and modifications as would occur to a person of skill in the art.

What is claimed is:

1. A method for implementing an instant lottery ticket game system played by a plurality of jurisdictions, comprising:
designating a first set of instant lottery tickets in a primary game for each of the jurisdictions;
assigning at least one top prize in the primary game;
assigning an independent predetermined prize structure for lesser prizes in the primary game to each of the first sets such that each jurisdiction has an independent prize structure for the lesser prizes;
providing indicia on each of the instant lottery tickets in all of the first sets that identifies a chance to win the top prize;
for each of the first sets, defining an independent number of the instant lottery tickets as eligible tickets with a chance to win the top prize in the primary game;
from a pool representing the eligible tickets from all of the first sets, randomly assigning the top prize to one of the eligible tickets to designate a top prize winning ticket to be subsequently printed;
printing the first sets of instant lottery tickets, wherein the top prize winning ticket is located within one of the first sets; and
maintaining identity and location of the top prize winning ticket secret from the jurisdictions before and during play of the primary game in the jurisdictions.

2. The method of claim 1, comprising assigning a plurality of the top prizes in the primary game and randomly assigning each of the top prizes to a respective eligible ticket from the pool of eligible tickets, wherein all of the top prize winning tickets are printed and located in one or more of the first sets.

3. The method of claim 1, comprising randomly assigning each of a plurality of instant-win prizes to a respective eligible ticket from the pool of eligible tickets, thereby designating and printing instant-win prize tickets that are located in one or more of the first sets.

4. The method of claim 3, wherein each of the instant lottery tickets in all of the first sets includes play area indicia that identifies whether or not the instant lottery ticket is the top prize winning ticket or an instant-win prize ticket.

5. The method of claim 1, wherein the number of eligible tickets within each of the first sets is determined based on a number of the instant lottery tickets provided to each of the jurisdictions in the primary game.

6. The method of claim 1, wherein the number of eligible tickets within each of the first sets is randomly determined.

7. The method of claim 1, wherein each jurisdiction establishes its own predetermined prize structure for the lesser prizes in the primary game separate from other jurisdictions.

8. The method of claim 7, further comprising generating a validation file for each jurisdiction that contains a record for each of the instant lottery tickets in the first set winning a lesser prize, the respective validation file provided to each jurisdiction and being void of a record or information that identifies location of the top prize winning ticket to the jurisdiction.

9. The method of claim 8, further comprising generating a confirmation file that contains information to validate the top prize winning ticket, the confirmation file maintained by a lottery provider or third party without access thereto by the jurisdictions.

10. The method of claim 9, wherein the top prize winning ticket includes instructions to a player on how to validate the top prize winning ticket via the lottery provider or third party separate from a validation process maintained by the jurisdiction for the lesser prizes in the primary game.

11. The method of claim 10, wherein the top prize is awarded to the player by the jurisdiction in which the top prize winning ticket was sold.

12. The method of claim 1, wherein the instant lottery tickets are scratch-off lottery tickets having game play indicia for the lesser prizes and indicia indicating whether the top prize has been won under a removable scratch-off coating.

13. An instant lottery ticket game system for play in a plurality of jurisdictions, comprising:
a first set of instant lottery tickets for a primary game for each of the jurisdictions;
at least one top prize in the primary game;
an independent predetermined prize structure for lesser prizes in the primary game for each of the first sets such that each jurisdiction has an independent prize structure for the lesser prizes;
indicia on each of the instant lottery tickets in all of the first sets that identifies a chance to win the top prize;
wherein for each of the first sets, an independent defined number of the instant lottery tickets having been designated as eligible tickets with a chance to win the top prize in the primary game;
wherein from a pool of the eligible tickets from all of the first sets, one of the eligible tickets having been randomly assigned as a top prize winning ticket that wins the top prize; and
wherein identity and location of the top prize winning ticket is maintained secret from the jurisdictions before and during play of the primary game in the jurisdictions.

14. The system of claim 13, comprising a plurality of the top prizes and top prize winning tickets in the primary game having been randomly assigned to a respective one of the eligible tickets in the pool of eligible tickets, the top prize winning tickets located in one or more of the first sets.

15. The system of claim 13, comprising a plurality of instant-win prizes and instant win prize tickets having been randomly assigned to a respective one of the eligible tickets in the pool of eligible tickets, the instant win prizes having a lesser value than the top prize, the instant win prize tickets located in one or more of the first sets.

16. The system of claim 15, wherein each of the instant lottery tickets in all of the first sets comprises play area indicia that identifies whether or not the instant lottery ticket is the top prize winning ticket or an instant-win prize ticket.

17. The system of claim 13, wherein the independent prize structures are independently determined by each jurisdiction.

18. The system of claim 17, further comprising a validation file for each jurisdiction that contains a record of each of the instant lottery tickets in the first set winning a lesser prize, the validation file being void of a record or information that identifies location of the top prize winning ticket to the jurisdiction.

19. The system of claim 18, further comprising a confirmation file that contains information to validate the top prize winning ticket, the confirmation file maintained by a lottery provider or third party without access thereto by the jurisdictions.

20. The system of claim 19, wherein the top prize winning ticket comprises instructions to a player on how to validate the top prize eligible ticket via the lottery provider or third party separate from a validation process maintained by the jurisdiction for the lesser prizes in the primary game.
